(19) United States
(12) Patent Application Publication
(10) Pub. No.: US 2003/0228405 A1
(43) Pub. Date: Dec. 11, 2003

(54) Heterogeneous konjak and manufacturing method therefor

(76) Inventor: Yasuo Mukohata, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/960,985

(22) Filed: Sep. 25, 2001

(30) Foreign Application Priority Data
Sep. 20, 2000 (JP) 2000-285059
Nov. 27, 2000 (JP) 2000-359332

(51) Int. Cl. A23L 1/0522

(52) U.S. Cl. 426/550; 426/578

(57) ABSTRACT

Disclosed a heterogeneous konjak and a method for manufacturing the same. In order to provide a konjak different in feelings on the tongue and to the teeth, the heterogeneous konjak comprises plural base konjak members formed in various shapes and having different properties and a filler konjak enclosing the base konjak members. The base konjak members differ from the filler konjak in hardness due to water content and/or in content of texture induced partly or thoroughly by thawing frozen base konjak members. The heterogeneous konjak is made by preparing firstly the base konjak members in the above form and secondly mixing the separately prepared filler konjak and said base konjak members and then gelating the total mixture.

### BACKGROUND OF THE INVENTION

1. Field of the Invention

The present invention relates to an edible konjak and its manufacturing method, especially a heterogeneous konjak and a method for manufacturing the same. The “konjak” means a gelatinous food made from devil's tongue starch.

2. Related Arts

Edible konjak foods are sometimes prepared from the ground matter of konjak bulbs, but are generally prepared with refined konjak flour made from konjak bulbs. For preparing the refined konjak flour, konjak bulbs are washed, peeled, dried, chopped, and subsequently ground to obtain crude powder, then sieved for separating the refined flour. Konjak is generally prepared by slowly mixing 10 volume % of the konjak flour with lukewarm water, agitating and then cooling the mixture by standing to bring the konjak flour to sufficiently absorb water, subsequently adding about 1.5 times volume of lukewarm water divided in several times during continuous kneading, adding a coagulant, e.g., lime milk (prepared by dissolving 5 g of slaked lime in 350 ml of water) or a sodium carbonate solution (prepared by dissolving 10 g of sodium carbonate in 350 ml of water) when the mixture becomes pasty and sufficiently colloidal, agitating the mixture, pouring the mixture into a big mold, warming the mixture, taking the mixture out of the mold when the mixture solidifies to some extent, cutting the half-solidified mixture in a predetermined size and shape, putting the cut pieces into slaked lime-containing warm water (prepared by dissolving 4 g of slaked lime in 100 l of water, at about 50° C.), warming for 15-30 minutes and removing the lye (harsh taste) by moving the pieces into clear and fresh water.

As general konjak products, those having angular and round shapes are common. As specific konjak products, noodles made of konjak (konjak spaghetti), shirataki (fine, whitish strings of konjak) and frozen konjak are cited. As particular konjak products, those enclosing ingredients such as peels of konjak bulbs, cayenne, green layer, seaweed (edible brown algae, Undaria pinnatifida, etc.) and the like are available. The konjak itself is little digestive, is absorbed little and has little nutritive value, but its elastic feeling to the teeth is favored, especially by Japanese, so the konjak is used as a food material for various cooking and said to be effective for improving constipation and for dieting.

However, they cannot bring about particular properties other than common feelings to the teeth and on the tongue as konjak, since they are homogeneous as konjak itself though the konjak products available as food materials have different elastic properties depending on difference in water contents.

One object of the present invention is to provide a konjak different in feelings on the tongue and to the teeth and provide a method for manufacturing the same. That is, the present invention is to bring the conventionally homogeneous konjak to a heterogeneous one and attain the object.

### SUMMARY OF THE INVENTION

A heterogeneous konjak can be obtained according to the present invention in that it comprises plural base konjak members formed in various shapes and having different properties and a filler konjak enclosing the base konjak members.

The base konjak members may be formed in a granular, string-like and/or tabular shape.

The base konjak members differs from the filler konjak (1) in hardness due to water content and/or (2) in content of texture induced partly or thoroughly by thawing the base konjak members frozen beforehand.

Such heterogeneous konjak is manufactured by a method in that it comprises:

a first step for preparing base konjak members by;

(a) adding water or lukewarm water to konjak flour or a ground matter of konjak bulbs to knead, adding a coagulant and kneading the mixture, pouring the mixture into a mold, warming the mixture to form a gel, taking out the gel from the mold and shaping the gel into a sheet-like, string-like, granular, dumpling-like shape or the like, or

(b) after adding the coagulant, warming the mixture to form the gel during shaping the mixture into the sheet-like, string-like, granular, dumpling-like shape or the like, or

(c) after shaping the gel in a sheet-like, string-like, granular, dumpling-like shape or the like, the shaped base konjak is frozen thoroughly or partly in a refrigerator and then thawed, and

a second step for preparing a filler konjak by;

adding water or lukewarm water to konjak flour or a ground matter of konjak bulbs in a different amount from that added to the base konjak to knead, adding the coagulant and kneading the mixture, mixing the kneaded mixture with the aforesaid shaped base konjak, introducing the mixture into the mold and warming and gelating the total mixture of the base konjak and the post-added konjak material to form the filler konjak.

In the method, the konjak flour itself may be used as a raw material for the filler konjak instead of the konjak flour kneaded with water or the ground matter of konjak bulbs. In this case, the second step for preparing a filler konjak may be replaced by a step of powdering konjak flour on the base konjak, putting it into a mold, warming the mold for gelating the konjak flour to adhere the base konjak together.

In carrying out the method of this invention, the water content of the base konjak can be brought to relatively lower than one of the filler konjak. In this case, the filler part of the heterogeneous konjak having the higher water content becomes relatively soft and less elastic. When this heterogeneous konjak is cooked and seasoned, the soft part is easily seasoned earlier, thus, difference occurs not only in feeling to the teeth but in taste of the part having higher elasticity, so the heterogeneous konjak is quite different from the conventional konjak in palatability and taste. Since the freeze-thaw base konjak, even made at the same content with the filler konjak, has higher texture content and spongier than the konjak without frozen history, some of the above properties of the heterogeneous konjak are enhanced.

In preparing the base konjak or the filler konjak or both of them according to the present invention, third ingredients such as peels of konjak bulbs, cayenne, sesame, green lava, sea weeds (brown algae, Undaria pinnatifida, etc.), minced onion and the like can be added to improve taste, color appearance or physical appearance.

Other objects and advantages of the present invention will be understood from the following description of the heterogeneous konjak and the method for manufacturing the same according to one preferred embodiment of the present invention.

### DETAILED DESCRIPTION OF PREFERRED EMBODIMENT

### MANUFACTURING EXAMPLE

The base konjak is obtained by adding 12 g of commercially available konjak flour into 400 ml of water, kneading the flour for two hours by a mixer [Kenmix (trademark) KM600, in 140 rpm main shaft revolution and 60 rpm precessional revolution], adding 20 ml of limewater (made by dissolving 1.5 g of calcium hydroxide in 100 ml of water), kneading the mixture for further 10 minutes, injecting the kneaded one into a mold, promoting gelation of the (kneaded) konjak (flour) in the mold by warming on a hot water bath for 20 minutes to obtain about 400 ml of the base konjak. The aforesaid base konjak is put into the aforesaid mixer attached with a mincing attachment and treated to obtain the granular base konjak having about 3 mm average diameter. The yield is about 250 ml.

While, the desired heterogeneous konjak is obtained by adding 8 g of the commercially available konjak flour into 400 ml of water, kneading the flour by the aforesaid mixer for 2 hours, adding 20 ml of the aforesaid limewater and further the aforesaid granular base konjak, kneading the mixture for about 3 minutes, subsequently putting the mixture in the mixer into a mold having approximately 9 cm inner diameter and approximately 4 cm depth and promoting gelation of the filler konjak in the mold by warming the mold on a hot water bath for 30 minutes.

### TEST EXAMPLE

The heterogeneous konjak obtained in the above-described example of the production is sliced in a circular disc-like shape (about 1 cm thick), then in a semicircular shape. The 8 sliced pieces of the heterogeneous konjak are added with tap water in which 1 piece (4.2 g) of consommé soup element [Maggy bouillon (trademark)], 15 ml of a thick sauce [Kagome Tonkatsu Sauce (trademark)] and 10 g of butter are dissolved and cooked for 1 hour.

Seven panelists (samplers) including the inventor tried to taste the obtained pieces of seasoned heterogeneous konjak. The impressions of the panelists are as follows:

Panelist A: I cannot realize that this is a konjak from its appearance and feeling on the tongue and to the teeth.

Panelist B: I cannot judge that this is a konjak from its palatability. It has a curious texture something like meat.

Panelist C: It is well seasoned though it is konjak, and its palatability is similar to meat.

Panelist D: I might not have known what I was tasting if had no information on the konjak. The feeling to the teeth is similar to that of hardened minced meat.

Panelist E: Suitable feeling to the teeth and feeling different from the aforesaid feeling are well spreading in the mouth. I think that the amount of the dama (granules of the base konjak) could be larger and when it is seasoned in a Japanese style, it could taste beyond my expectation.

Panelist F: It tastes like hamburger, but it seems that it contains a little more water. I feel that the base konjak should be a little smaller.

Panelist G: It is well seasoned in a short cooking time. The palatability could be fresher if the glueing material (the filler konjak) would be a little harder and less in its amount.

Consideration:

It seems that the heterogeneous konjak is suitable for a new food material, though some ideas such as to bring the base konjak a little harder, to bring the granular size smaller, to reduce the amount of the filler konjak relative to the base konjak and so forth are considered to be necessary. Comparing with the conventional homogeneous konjak, the heterogeneous konjak is not only different in appearance, hand feeling, palatability, feeling on the tongue and to the teeth, but also good in penetration of seasonings during cooking and can be cooked in a shorter time. It is considered that the interface between the base konjak and the filler konjak effectively contributes to penetrate seasonings into the heterogeneous konjak.

As may be understood from the above, the heterogeneous konjak of the present invention comprises the base konjak having different hardness/elasticity due to water content and/or spongy texture content induced by freezing-thawing from the filler konjak enclosing the base konjak, thereby providing following advantages:

a) In comparison with the conventional “homogeneous” konjak, the heterogeneous konjak is not only quite different in appearance, hand feeling, palatability, feeling on the tongue and to the teeth, but also the part of the konjak having the higher water content is easily and rapidly seasoned when cooked with a seasoning. Thus, a cooking time is brought to be shorter by constituting the filler konjak with the one having the higher water content.

b) The manufacturing of the heterogeneous konjak can be easily carried out since both of the base konjak and the filler konjak can be made in a conventional method.

What is claimed is:

1. A heterogeneous konjak comprising plural base konjak members formed in various shapes and having different properties and a filler konjak enclosing the base konjak members.

2. A heterogeneous konjak according to claim 1, wherein the base konjak members are formed in a granular, string-like and/or tabular shape.

3. A heterogeneous konjak according to claim 1, wherein the base konjak members differ from the filler konjak in hardness due to water content and/or in content of texture induced partly or thoroughly by thawing frozen base konjak members.

4. A method for manufacturing a heterogeneous konjak comprising:
a first step for preparing base konjak members by;
(a) adding water or lukewarm water to konjak flour or a ground matter of konjak bulbs to knead, adding a coagulant and kneading the mixture, pouring the mixture into a mold, warming the mixture to form a gel, taking out the gel from the mold and shaping the gel into a sheet-like, string-like, granular, dumpling-like shape or the like, or
(b) after adding the coagulant, warming the mixture to form the gel during shaping the mixture into the sheet-like, string-like, granular, dumpling-like shape or the like, or
(c) after shaping the gel in a sheet-like, string-like, granular, dumpling-like shape or the like, the shaped base konjak is frozen thoroughly or partly in a refrigerator and then thawed, and
a second step for preparing a filler konjak by;
adding water or lukewarm water to konjak flour or a ground matter of konjak bulbs in a different amount from that added to the base konjak to knead, adding the coagulant and kneading the mixture, mixing the kneaded mixture with the aforesaid shaped base konjak, introducing the mixture into the mold and warming and gelating the total mixture of the base konjak and the post-added konjak material to form the heterogeneous konjak.

5. A method for manufacturing a heterogeneous konjak comprising:
a first step for preparing base konjak members by;
(a) adding water or lukewarm water to konjak flour or a ground matter of konjak bulbs to knead, adding a coagulant and kneading the mixture, pouring the mixture into a mold, warming the mixture to form a gel, taking out the gel from the mold and shaping the gel into a sheet-like, string-like, granular, dumpling-like shape or the like, or
(b) after adding the coagulant, warming the mixture to form the gel during shaping the mixture into the sheet-like, string-like, granular, dumpling-like shape or the like, or
(c) after shaping the gel in a sheet-like, string-like, granular, dumpling-like shape or the like, the shaped base konjak is frozen thoroughly or partly in a refrigerator and then thawed, and
a second step for preparing a filler konjak by;
powdering konjak flour on the base konjak, putting it into a mold, warming the mold for gelating the konjak flour to adhere the base konjak together.
